(19) United States
(12) Patent Application Publication
(10) Pub. No.: US 2016/0232707 A1
(43) Pub. Date: Aug. 11, 2016

(54) IMAGE PROCESSING METHOD AND APPARATUS, AND COMPUTER DEVICE

(71) Applicant: TENCENT TECHNOLOGY (SHENZHEN) COMPANY LIMITED, Shenzhen (CN)

(72) Inventors: Yufei HAN, Shenzhen (CN); Xiaozheng JIAN, Shenzhen (CN); Hui ZHANG, Shenzhen (CN)

(21) Appl. No.: 15/130,531

(22) Filed: Apr. 15, 2016

Related U.S. Application Data
(63) Continuation of application No. PCT/CN2015/071225, filed on Jan. 21, 2015.

(30) Foreign Application Priority Data
Jan. 22, 2014 (CN) 201410030054.2

(51) Int. Cl. G06T 15/50; G06T 15/06

(52) U.S. Cl. CPC G06T 15/506; G06T 15/06; G06T 2215/12

(57) ABSTRACT

Embodiments of the present invention disclose an image processing method and apparatus, and a computer device. The image processing method includes: receiving information sent by a central processing unit (CPU), about a scene within a preset range around a to-be-rendered target object; rendering the received scene to obtain scene depth parameters, where the scene is obtained through shooting by a camera located at a ray light source; rendering the to-be-rendered target object to obtain rendering depth parameters, where the to-be-rendered target object is obtained through shooting by a camera not located at a ray light source; calculating ambient occlusion (AO) maps of the to-be-rendered target object in directions of ray light sources according to the scene depth parameters and the rendering depth parameters; and overlaying the AO maps in the directions of the ray light sources, to obtain an output image.

### CROSS-REFERENCE TO RELATED APPLICATIONS

The application is a continuation application of International Application PCT/CN2015/071225, entitled “IMAGE PROCESSING METHOD AND APPARATUS, AND COMPUTER DEVICE”, and filed on Jan. 21, 2015, which claims priority to Chinese Patent Application No. 201410030054.2, entitled “IMAGE PROCESSING METHOD AND APPARATUS, AND COMPUTER DEVICE” filed on Jan. 22, 2014, with the Chinese State Intellectual Property Office, both of which are incorporated herein by reference in their entirety.

### FIELD

Embodiments of the present invention relate to the field of image processing technologies, and in particular, to an image processing method and apparatus, and a computer device.

### BACKGROUND

Nowadays, network games are flourishing, and people have an increasingly higher requirement for the sense of reality of a scene in a game. Ambient occlusion (AO) is an essential part in a global illumination (GI) technology, and the AO describes an occlusion value between each point on the surface of an object and another object in a scene. Generally, an illumination value of light radiating on the surface of the object is attenuated by using the AO, so as to generate a shadow to enhance a layering sense of a space, enhance the sense of reality of the scene, and enhance artistry of a picture.

However, in a process of game development, the inventor of the present disclosure finds that, most mainstream AO map baking software on the market is based on a central processing unit (CPU), but efficiency of processing image data by the CPU is low; as a result, efficiency of AO map baking is very low, and generally, it takes several hours to bake one AO map; and some baking software may enable the CPU to execute one part of the processing process, and enable a graphic processing unit (GPU) to execute the other part of the processing process, but an algorithm involved in such baking software is always very complex, and finally, a problem that image processing efficiency is low is still caused. Therefore, it is necessary to provide a new method to solve the foregoing problem.

### SUMMARY

Embodiments of the present invention provide an image processing method and apparatus, and a computer device, which can improve image processing efficiency. The technical solutions are described as follows:

According to a first aspect, an image processing method is provided, where the image processing method includes: receiving, by a GPU, information, which is sent by a CPU, about a scene within a preset range around a to-be-rendered target object; rendering, by the GPU, the scene to obtain scene depth parameters, where the scene is obtained through shooting by a camera located at a ray light source; rendering, by the GPU, the to-be-rendered target object to obtain rendering depth parameters, where the to-be-rendered target object is obtained through shooting by a camera not located at a ray light source; calculating, by the GPU, AO maps of the to-be-rendered target object in directions of ray light sources according to the scene depth parameters and the rendering depth parameters; and overlaying, by the GPU, the AO maps in the directions of the ray light sources, to obtain an output image.

According to a second aspect, an image processing apparatus is provided, where the image processing apparatus includes: a receiving unit, that receives information, which is sent by a CPU, about a scene within a preset range around a to-be-rendered target object; a rendering processing unit, that renders the scene to obtain scene depth parameters, where the scene is obtained through shooting by a camera located at a ray light source; and renders the to-be-rendered target object to obtain rendering depth parameters, where the to-be-rendered target object is obtained through shooting by a camera not located at a ray light source; a map generating unit, that calculates AO maps of the to-be-rendered target object in directions of ray light sources according to the scene depth parameters and the rendering depth parameters; and an output processing unit, that overlays the AO maps in the directions of the ray light sources, to obtain an output image.

According to a third aspect, a computer device is provided, where the computer device includes a CPU and a GPU, where the CPU determines ray points that use a to-be-rendered target object as a center and are distributed in a spherical shape or a semispherical shape, and establishes, at a position of each ray point, a ray light source that radiates light towards the to-be-rendered target object; and the GPU receives information, which is sent by the CPU, about a scene within a preset range around a to-be-rendered target object; renders the scene to obtain scene depth parameters, where the scene is obtained through shooting by a camera located at a ray light source; renders the to-be-rendered target object to obtain rendering depth parameters, where the to-be-rendered target object is obtained through shooting by a camera not located at a ray light source; calculate AO maps of the to-be-rendered target object in directions of ray light sources according to the scene depth parameters and the rendering depth parameters; and overlays the AO maps in the directions of the ray light sources, to obtain an output image.

It may be seen from the foregoing technical solutions that, the embodiments of the present invention have following advantages:

In the embodiments of the present invention, a GPU receives information, which is sent by a CPU, about a scene within a preset range around a to-be-rendered target object; the GPU renders the received scene to obtain scene depth parameters; the GPU renders the to-be-rendered target object to obtain rendering depth parameters; the GPU calculates AO maps of the to-be-rendered target object in directions of ray light sources according to the scene depth parameters and the rendering depth parameters; and the GPU overlays the AO maps in the directions of the ray light sources, to obtain an output image. In the embodiments of the present invention, AO maps of a to-be-rendered target object in directions of ray light sources can be calculated only according to scene depth parameters and rendering depth parameters, and an output image can be obtained by simply overlaying the AO maps in the directions of the ray light sources, which therefore avoids a complex calculation process in the prior art; and these image calculation and processing processes are completed by a GPU, and a powerful capability of the GPU for processing image data is utilized, which improves image processing efficiency.

### BRIEF DESCRIPTION OF THE DRAWINGS

To describe the technical solutions of the embodiments of the present invention or the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic diagram of an embodiment of an image processing method according to the present disclosure;

FIG. 2 is a schematic diagram of another embodiment of an image processing method according to the present disclosure;

FIG. 3 is a schematic diagram of an embodiment of an image processing apparatus according to the present disclosure;

FIG. 4 is a schematic diagram of another embodiment of an image processing apparatus according to the present disclosure;

FIG. 5 is a schematic diagram of an embodiment of a computer device according to the present disclosure;

FIG. 6 is an output image on which a Gamma correction is not performed; and

FIG. 7 is an output image on which a Gamma correction is performed.

### DETAILED DESCRIPTION

To make the objectives, technical solutions, and advantages of the present disclosure more comprehensible, the following further describes the embodiments of the present disclosure in detail with reference to the accompanying drawings. Apparently, the described embodiments are merely some rather than all of the embodiments of the present invention. All other embodiments obtained by a person of ordinary skill in the art based on the embodiments of the present invention without creative efforts shall fall within the protection scope of the present disclosure.

Embodiments of the present invention provide an image processing method and apparatus, and a computer device, which can improve image processing efficiency.

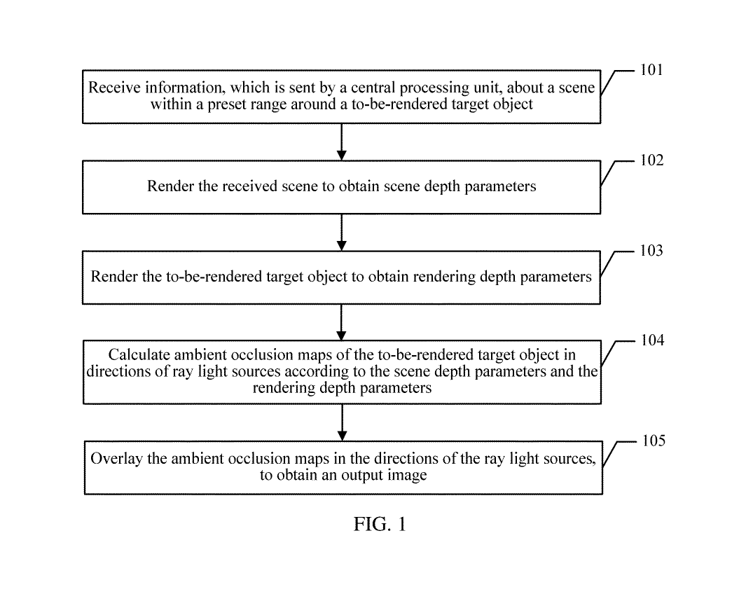

Referring to FIG. 1, FIG. 1 is a schematic diagram of an embodiment of an image processing method according to the present disclosure. The image processing method in this embodiment includes:

101: A GPU receives information, which is sent by a CPU, about a scene within a preset range around a to-be-rendered target object.

In this embodiment, a model of the to-be-rendered target object is established in the CPU, ray light sources are set, and the CPU shoots the to-be-rendered target object by using a simulated camera located at a ray light source, to obtain the information about the scene within the preset range around the to-be-rendered target object, where the preset range may be preset in the CPU according to an actual need, and the obtained scene may include the to-be-rendered target object and another object, terrain, or the like. The CPU sends the obtained information about the scene within the preset range around the to-be-rendered target object to the GPU, so that the GPU performs further processing.

102: The GPU renders the received scene to obtain scene depth parameters.

The GPU receives the information, which is sent by the CPU, about the scene within the preset range around the to-be-rendered target object, and renders the received scene to obtain the scene depth parameters.

103: The GPU renders the to-be-rendered target object to obtain rendering depth parameters.

The GPU shoots the to-be-rendered target object separately by utilizing a camera not located at a ray light source, and renders the to-be-rendered target object to obtain the rendering depth parameters. When the GPU shoots the to-be-rendered target object by utilizing the camera not located at a ray light source, a selected shooting angle needs to enable the entire to-be-rendered target object to be shot.

104: The GPU calculates AO maps of the to-be-rendered target object in directions of ray light sources according to the scene depth parameters and the rendering depth parameters.

In a specific implementation, there may be multiple ray light sources, and the GPU calculates the AO maps of the to-be-rendered target object in the directions of the ray light sources according to a scene depth parameter and a rendering depth parameter of the to-be-rendered target object in a direction of each ray light source.

105: The GPU overlays the AO maps in the directions of the ray light sources, to obtain an output image.

In this embodiment, AO maps of a to-be-rendered target object in directions of ray light sources can be calculated only according to scene depth parameters and rendering depth parameters, and an output image can be obtained by simply overlaying the AO maps in the directions of the ray light sources, which avoids a complex calculation process in the prior art; and these image calculation and processing processes are completed by a GPU, and a powerful capability of the GPU for processing image data is utilized, which improves image processing efficiency.

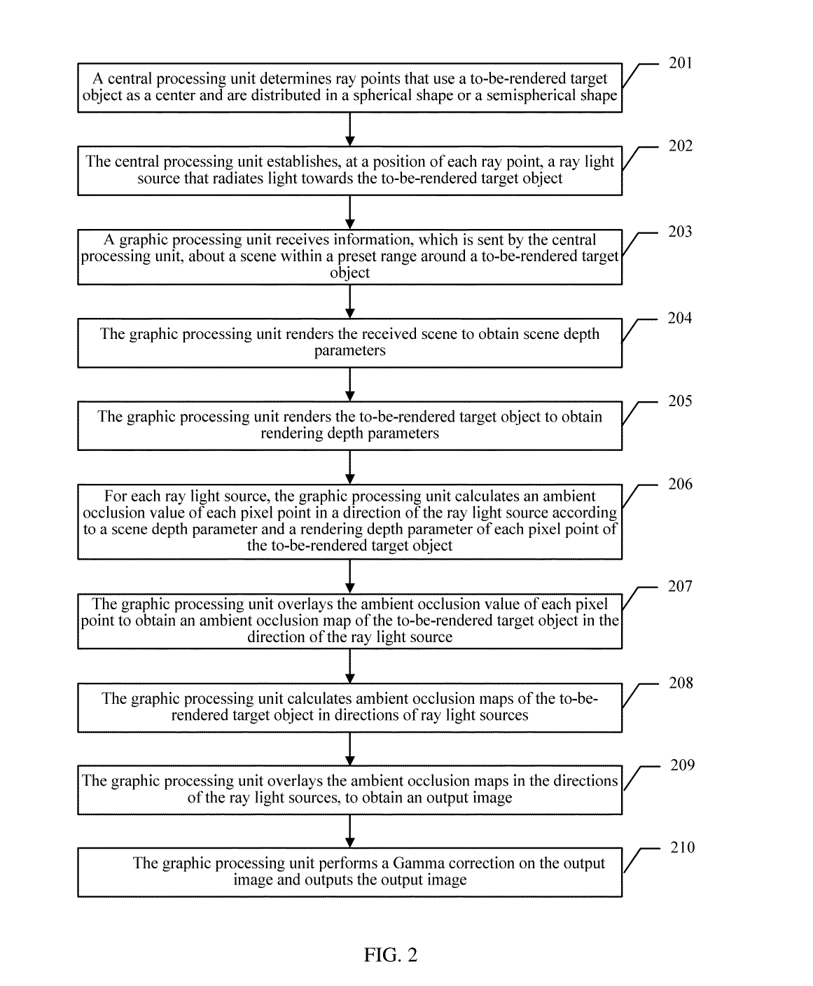

For ease of understanding, the following describes the image processing method in this embodiment of the present invention by using a specific embodiment. Referring to FIG. 2, the image processing method in this embodiment includes:

201: A CPU determines ray points that use a to-be-rendered target object as a center and are distributed in a spherical shape or a semispherical shape.

In this embodiment, a model of the to-be-rendered target object is established in the CPU, and then the CPU determines the ray points that use the to-be-rendered target object as the center and are evenly distributed in the spherical shape or the semispherical shape.

202: The CPU establishes, at a position of each ray point, a ray light source that radiates light towards the to-be-rendered target object.

The CPU establishes, at the position of each ray point, the ray light source, where the ray light source radiates light towards the to-be-rendered target object. Preferably, the number of ray light sources is 900.

The CPU shoots the to-be-rendered target object by using a simulated camera located at a ray light source, to obtain information about a scene within a preset range around the to-be-rendered target object, where the preset range may be preset in the CPU according to an actual need, a manner in which the camera shoots the to-be-rendered target object may be a parallel projection matrix manner, and the obtained scene may include the to-be-rendered target object and another object, terrain, or the like.

To ensure the accuracy of image drawing, the CPU may filter out dynamic objects in the obtained scene within the preset range around the to-be-rendered target object, where these dynamic objects are, for example, a particle and an animation with a skeleton, and send information about the scene within the preset range around the to-be-rendered target object after the filtration to the GPU, so that the GPU perform further processing.

Specifically, the CPU may send the obtained information about the scene to the GPU by utilizing algorithms such as a quadtree, an octree, and a Jiugong. In addition, the information sent to the GPU may further include relevant parameters of the camera at the ray light source, for example, a vision matrix, a projection matrix, and a lens position.

203: A GPU receives information, which is sent by the CPU, about a scene within a preset range around a to-be-rendered target object.

The scene received by the GPU is obtained through shooting by the camera at the ray light source.

204: The GPU renders the received scene to obtain scene depth parameters.

The GPU renders the received scene to obtain a scene depth image, where the scene depth image stores a scene depth parameter of each pixel point in the scene shot by the camera at the ray light source, that is, also includes a scene depth parameter of each pixel point of the to-be-rendered target object.

205: The GPU renders the to-be-rendered target object to obtain rendering depth parameters.

The to-be-rendered target object is obtained through shooting by a camera not located at a ray light source, where the camera may shoot the to-be-rendered target object separately in a parallel projection manner, and a selected shooting angle needs to enable the entire to-be-rendered target object to be shot.

The GPU renders the to-be-rendered target object, and obtains a rendering depth image after the rendering, obtains a vertex coordinate of the to-be-rendered target object from the rendering depth image, and multiplies the vertex coordinate of the to-be-rendered target object by a world coordinate matrix, and then by vision matrixes and projection matrixes of cameras located at the ray light sources, to obtain the rendering depth parameters of the to-be-rendered target object. The rendering depth parameters of the to-be-rendered target object include a rendering depth parameter of each pixel point of the to-be-rendered target object.

206: For each ray light source, the GPU calculates an AO value of each pixel point in a direction of the ray light source according to a scene depth parameter and a rendering depth parameter of each pixel point of the to-be-rendered target object.

For each ray light source, the GPU obtains a scene depth parameter corresponding to the to-be-rendered target object shot by the camera at the ray light source, and the rendering depth parameter of the to-be-rendered target object shot by the camera not located at any ray light source, and calculates the AO value of each pixel point in the direction of the ray light source according to the scene depth parameter and the rendering depth parameter of each pixel point of the to-be-rendered target object, which is specifically as follows:

For a pixel point, the GPU compares a rendering depth parameter of the pixel point with a scene depth parameter of the pixel point, and determines, when the rendering depth parameter is greater than the scene depth parameter, that a shadow value of the pixel point is 1; and determines, when the rendering depth parameter of the pixel point is less than or equal to the scene depth parameter, that the shadow value of the pixel point is 0.

The GPU multiplies the shadow value of the pixel point by a weight coefficient to obtain an AO value of the pixel point in the direction of the ray light source, where the weight coefficient includes a dot product of an illumination direction of the ray light source and a normal direction of the pixel point, and a reciprocal of a total number of the ray light sources, for example, when the number of the ray light sources is 900, the reciprocal of the total number of the ray light sources is 1/900.

In addition, to ensure calculation accuracy for the AO value of each the pixel point, the foregoing AO value obtained through calculation may be further multiplied by a preset experience coefficient, where the experience coefficient is measured according to an experiment, and may be 0.15.

207: The GPU overlays the AO value of each pixel point to obtain an AO map of the to-be-rendered target object in the direction of the ray light source.

The GPU overlays the AO value of each pixel point to obtain the AO value of the to-be-rendered target object, and draws the AO map of the to-be-rendered target object in the direction of the ray light source according to the AO value of the to-be-rendered target object.

208: The GPU calculates AO maps of the to-be-rendered target object in directions of ray light sources.

By analogy, the GPU may obtain an AO map of the to-be-rendered target object in a direction of each ray light source according to the foregoing method.

209: The GPU overlays the AO maps in the directions of the ray light sources, to obtain an output image.

A black border may be generated on the output image due to sawteeth and texture pixel overflowing. The black border generated due to the sawteeth may be processed by using “percentage progressive filtration” of a shadow, and for each pixel, pixels above, below, to the left of, and to the right of this pixel, and this pixel itself are averaged. The black border generated due to the pixel overflowing may be solved by expanding effective pixels. Specifically, whether a current pixel is ineffective may be determined in a pixel shader. If the current pixel is ineffective, 8 surrounding pixels are sampled, and effective pixels thereof are added up, an average value of the effective pixels is obtained, the average value is used as a shadow value of the current pixel, and the current pixel is set to be effective. In this way, expansion of one pixel for the output image to prevent sampling from crossing a boundary is implemented.

210: The GPU performs a Gamma correction on the output image and outputs the output image.

The GPU performs the Gamma correction on the output image, that is, the GPU pastes the output image onto the model of the to-be-rendered target object for displaying, and adjusts a display effect of the output image by using a color chart, to solve a problem that a scene dims as a whole because AO is added to the scene.

In this embodiment, AO maps of a to-be-rendered target object in directions of ray light sources can be calculated only according to scene depth parameters and rendering depth parameters, and an output image can be obtained by simply overlaying the AO maps in the directions of the ray light sources, which avoids a complex calculation process in the prior art; and these image calculation and processing processes are completed by a GPU, and a powerful capability of the GPU for processing image data is utilized, which improves image processing efficiency.

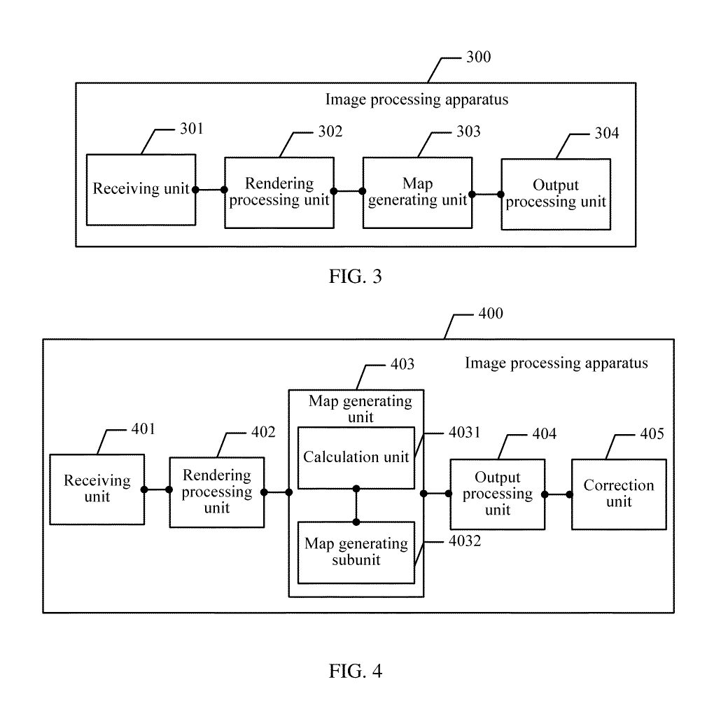

The following describes an image processing apparatus provided by an embodiment of the present invention. Referring to FIG. 3, the image processing apparatus 300 includes:

a receiving unit 301, that receives information, which is sent by a CPU, about a scene within a preset range around a to-be-rendered target object;

a rendering processing unit 302, that renders the received scene to obtain scene depth parameters, where the scene is obtained through shooting by a camera located at a ray light source; and renders the to-be-rendered target object to obtain rendering depth parameters, where the to-be-rendered target object is obtained through shooting by a camera not located at a ray light source;

a map generating unit 303, that calculates AO maps of the to-be-rendered target object in directions of ray light sources according to the scene depth parameters and the rendering depth parameters; and

an output processing unit 304, that overlays the AO maps in the directions of the ray light sources, to obtain an output image.

To further understand the technical solutions of the present disclosure, the following describes a manner in which the units in the image processing apparatus 300 in this embodiment interact with each other, which is specifically as follows:

In this embodiment, a model of the to-be-rendered target object is established in the CPU, ray light sources are set, and the CPU shoots the to-be-rendered target object by using a simulated camera located at a ray light source, to obtain the information about the scene within the preset range around the to-be-rendered target object, where the preset range may be preset in the CPU according to an actual need, and the obtained scene may include the to-be-rendered target object and another object, terrain, or the like. The CPU sends the obtained information about the scene within the preset range around the to-be-rendered target object to the image processing apparatus, and the receiving unit 301 receives the information, which is sent by the CPU, about the scene within the preset range around the to-be-rendered target object.

The rendering processing unit 302 renders the scene received by the receiving unit 301, to obtain the scene depth parameters, where the scene received by the rendering processing unit 302 is obtained through shooting by the camera located at the ray light source, and renders the to-be-rendered target object to the obtain rendering depth parameters, where the to-be-rendered target object is obtained through shooting by the camera not located at a ray light source. When the to-be-rendered target object is shot by utilizing the camera not located at a ray light source, a selected shooting angle needs to enable the entire to-be-rendered target object to be shot.

The map generating unit 303 calculates the AO maps of the to-be-rendered target object in the directions of the ray light sources according to the scene depth parameters and the rendering depth parameters obtained by the rendering processing unit 302. In a specific implementation, there may be multiple ray light sources, and the map generating unit 303 calculates the AO maps of the to-be-rendered target object in the directions of the ray light sources according to a scene depth parameter and a rendering depth parameter of the to-be-rendered target object in a direction of each ray light source.

The output processing unit 304 overlays the AO maps in the directions of the ray light sources, which are generated by the map generating unit 303, to obtain the output image.

In this embodiment, the map generating unit can calculate AO maps of a to-be-rendered target object in directions of ray light sources only according to scene depth parameters and rendering depth parameters, and the output processing unit can obtain an output image by simply overlaying the AO maps in the directions of the ray light sources, which avoids a complex calculation process in the prior art; and an image data processing capability that the image processing apparatus in this embodiment has is more powerful than an image data processing capability of a CPU, which improves image processing efficiency.

For ease of understanding, the following further describes an image processing apparatus provided by an embodiment of the present invention. Referring to FIG. 4, the image processing apparatus 400 includes:

a receiving unit 401, that receives information, which is sent by a CPU, about a scene within a preset range around a to-be-rendered target object;

a rendering processing unit 402, that renders the received scene to obtain scene depth parameters, where the scene is obtained through shooting by a camera located at a ray light source; and renders the to-be-rendered target object to obtain rendering depth parameters, where the to-be-rendered target object is obtained through shooting by a camera not located at a ray light source;

a map generating unit 403, that calculates AO maps of the to-be-rendered target object in directions of ray light sources according to the scene depth parameters and the rendering depth parameters, where

specifically, the map generating unit 403 includes a calculation unit 4031 and a map generating subunit 4032, where

the calculation unit 4031, for each ray light source, calculates an AO value of each pixel point in a direction of the ray light source according to a scene depth parameter and a rendering depth parameter of each pixel point of the to-be-rendered target object; and

the map generating subunit 4032 that overlays the AO values to obtain an AO map of the to-be-rendered target object in the direction of the ray light source;

an output processing unit 404, that overlays the AO maps in the directions of the ray light sources, to obtain an output image; and

a correction unit 405, that performs a Gamma correction on the output image and output the output image.

To further understand the technical solutions of the present disclosure, the following describes a manner in which the units in the image processing apparatus 400 in this embodiment interact with each other, which is specifically as follows:

In this embodiment, a model of the to-be-rendered target object is established in the CPU, ray light sources are set, and the CPU shoots the to-be-rendered target object by using a simulated camera located at a ray light source, to obtain the information about the scene within the preset range around the to-be-rendered target object, where the preset range may be preset in the CPU according to an actual need, and the obtained scene may include the to-be-rendered target object and another object, terrain, or the like. The CPU sends the obtained information about the scene within the preset range around the to-be-rendered target object to the image processing apparatus, and the receiving unit 401 receives the information, which is sent by the CPU, about the scene within the preset range around the to-be-rendered target object. The scene received by the receiving unit 401 includes the to-be-rendered target object and another object, terrain, or the like, and the received information about the scene may further include relevant parameters of the camera at the ray light source, for example, a vision matrix, a projection matrix, and a lens position.

The rendering processing unit 402 renders the scene received by the receiving unit 401, to obtain a scene depth image, where the scene depth image stores a scene depth parameter of each pixel point in the scene shot by the camera at the ray light source, that is, also includes a scene depth parameter of each pixel point of the to-be-rendered target object.

Next, the rendering processing unit 402 renders the to-be-rendered target object to obtain the rendering depth parameters, where the to-be-rendered target object is obtained through shooting by the camera not located at a ray light source, where the camera may shoot the to-be-rendered target object separately in a parallel projection manner, and a selected shooting angle needs to enable the entire to-be-rendered target object to be shot.

Specifically, the rendering processing unit 402 renders the to-be-rendered target object, and obtains a rendering depth image after the rendering, obtains a vertex coordinate of the to-be-rendered target object from the rendering depth image, and multiplies the vertex coordinate of the to-be-rendered target object by a world coordinate matrix, and then by vision matrixes and projection matrixes of cameras located at the ray light sources, to obtain the rendering depth parameters of the to-be-rendered target object. The rendering depth parameters of the to-be-rendered target object include a rendering depth parameter of each pixel point of the to-be-rendered target object.

The map generating unit 403 calculates the AO maps of the to-be-rendered target object in the directions of the ray light sources according to the scene depth parameters and the rendering depth parameters obtained by the rendering processing unit 402.

Specifically, for each ray light source, the calculation unit 4031 obtains a scene depth parameter corresponding to the to-be-rendered target object shot by the camera at the ray light source, and the rendering depth parameter of the to-be-rendered target object shot by the camera not located at any ray light source, and calculates the AO value of each pixel point in the direction of the ray light source according to the scene depth parameter and the rendering depth parameter of each pixel point of the to-be-rendered target object, and a calculation process is as follows:

For a pixel point, the calculation unit 4031 compares a rendering depth parameter of the pixel point with a scene depth parameter of the pixel point, and determines, when the rendering depth parameter is greater than the scene depth parameter, that a shadow value of the pixel point is 1; and determines, when the rendering depth parameter of the pixel point is less than or equal to the scene depth parameter, that the shadow value of the pixel point is 0.

Then, the calculation unit 4031 multiplies the shadow value of the pixel point by a weight coefficient to obtain the AO value of the pixel point in the direction of the ray light source, where the weight coefficient includes a dot product of an illumination direction of the ray light source and a normal direction of the pixel point, and a reciprocal of a total number of the ray light sources, for example, when the number of the ray light sources is 900, the reciprocal of the total number of the ray light sources is 1/900.

In addition, to ensure calculation accuracy for the AO value of each the pixel point, the calculation unit 4031 may further multiply the foregoing AO value obtained through calculation by a preset experience coefficient, where the experience coefficient is measured according to an experiment, and may be 0.15.

The map generating subunit 4032 overlays the AO value of each pixel point calculated by the calculation unit 4031 to obtain the AO value of the to-be-rendered target object, and draws the AO map of the to-be-rendered target object in the direction of the ray light source according to the AO value of the to-be-rendered target object. By analogy, the map generating subunit 4032 may obtain an AO map of the to-be-rendered target object in a direction of each ray light source according to the foregoing method.

The output processing unit 404 overlays the AO maps in the directions of the ray light sources, which are generated by the map generating subunit 4032, to obtain the output image.

A black border may be generated on the output image due to sawteeth and texture pixel overflowing. The output processing unit 404 may process the black border generated due to the sawteeth by using “percentage progressive filtration” of a shadow, and for each pixel, average pixels above, below, to the left of, and to the right of this pixel, and this pixel itself. The output processing unit 404 may solve the black border generated due to the pixel overflowing by expanding effective pixels. Specifically, whether a current pixel is ineffective may be determined in a pixel shader. If the current pixel is ineffective, 8 surrounding pixels are sampled, and effective pixels thereof are added up, an average value of the effective pixels is obtained, the average value is used as a shadow value of the current pixel, and the current pixel is set to be effective. In this way, expansion of one pixel for the output image to prevent sampling from crossing a boundary is implemented.

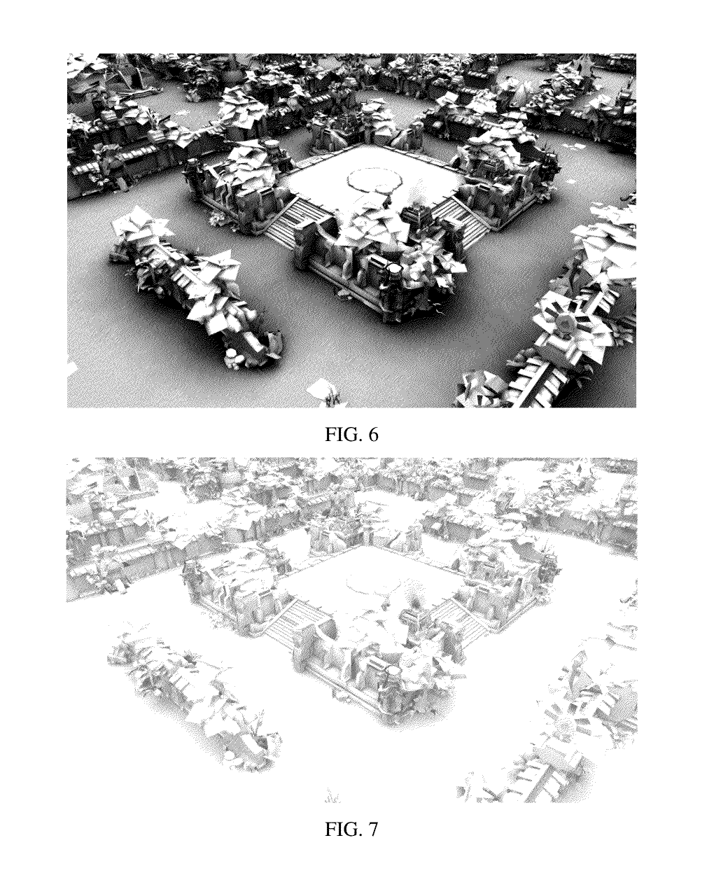

Finally, the correction unit 405 performs the Gamma correction on the output image of the output processing unit 404, that is, the correction unit 405 pastes the output image onto the model of the to-be-rendered target object for displaying, and adjusts a display effect of the output image by using a color chart, to solve a problem that a scene dims as a whole because AO is added to the scene. For a specific correction effect, refer to FIG. 6 and FIG. 7, where FIG. 6 shows a display effect of the output image on which the Gamma correction is performed, and FIG. 7 shows a display effect of the output image on which the Gamma correction is performed.

In this embodiment, the map generating unit can calculate AO maps of a to-be-rendered target object in directions of ray light sources only according to scene depth parameters and rendering depth parameters, and the output processing unit can obtain an output image by simply overlaying the AO maps in the directions of the ray light sources, which avoids a complex calculation process in the prior art; and an image data processing capability that the image processing apparatus in this embodiment has is more powerful than an image data processing capability of a CPU, which improves image processing efficiency. It is measured through an experiment that, it takes only several minutes to generate one AO map by using the image processing apparatus provided by this embodiment, and the used time is far shorter than the time for generating an AO map in the prior art.

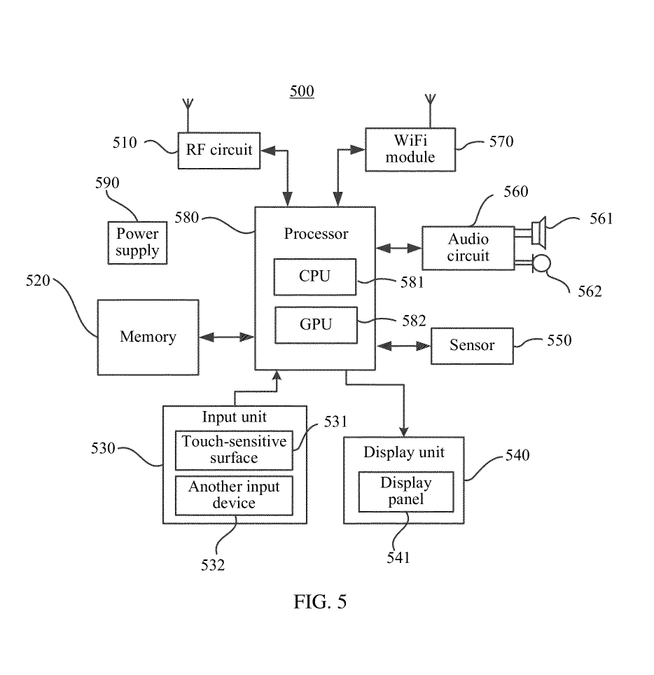

The following describes a computer device provided by an embodiment of the present invention. Referring to FIG. 5, the computer device 500 may include components such as a Radio Frequency (RF) circuit 510, a memory 520 that includes one or more computer readable storage mediums, an input unit 530, a display unit 540, a sensor 550, an audio circuit 560, a Wi-Fi module 570 (e.g., WiFi module, wireless fidelity module), a processor 580 that includes one or more processing cores, and a power supply 590.

A person skilled in the art can understand that, the structure of the computer device shown in FIG. 5 does not constitute a limit to the computer device, and may include components that are more or fewer than those shown in the figure, or a combination of some components, or different component arrangements.

The RF circuit 510 may receive and send a message, or receive and send a signal during a call, and particularly, after receiving downlink information of a base station, submit the information to one or more processors 580 for processing; and in addition, send involved uplink data to the base station. Generally, the RF circuit 510 includes but is not limited to an antenna, at least one amplifier, a tuner, one or more oscillators, a subscriber identity module (SIM) card, a transceiver, a coupler, a low noise amplifier (LNA), and a duplexer. In addition, the RF circuit 510 may further communicate with another device through wireless communication and a network; and the wireless communication may use any communications standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), e-mail, and Short Messaging Service (SMS).

The memory 520 may store a software program and a module, and the processor 580 executes various functional applications and data processing by running the software program and module that are stored in the memory 520. The memory 520 may mainly include a program storage area and a data storage area, where, the program storage area may store an operating system, an application program required by at least one function (for example, a voice playback function and an image playback function), and the like; the data storage area may store data (for example, audio data and a telephone directory) created according to use of the computer device 500, and the like; in addition, the memory 520 may include a high speed random access memory (RAM), and may further include a non-volatile memory, for example, at least one magnetic disk storage device, a flash memory, or another volatile solid-state memory. Accordingly, the memory 520 may further include a memory controller, so that the processor 580 and the input unit 530 access the memory 520.

The input unit 530 may receive input digit or character information, and generate keyboard, mouse, joystick, optical, or track ball signal input related to user setting and function control. Specifically, the input unit 530 may include a touch-sensitive surface 531 and another input device 532. The touch-sensitive surface 531 may also be referred to as a touch screen or a touch panel, and may collect a touch operation of a user on or near the touch-sensitive surface 531 (such as, an operation of a user on or near the touch-sensitive surface 531 by using any suitable object or attachment, such as a finger or a touch pen), and drive a corresponding connection apparatus according to a preset program. Optionally, the touch-sensitive surface 531 may include two parts: a touch detection apparatus and a touch controller. The touch detection apparatus detects a touch position of the user, detects a signal brought by the touch operation, and transfers the signal to the touch controller. The touch controller receives touch information from the touch detection apparatus, converts the touch information to touch point coordinates, and sends the touch point coordinates to the processor 580. Moreover, the touch controller can receive and execute a command sent from the processor 580. In addition, the touch-sensitive surface 531 may be implemented by using various types such as a resistive type, a capacitive type, an infrared type, and a surface sound wave type. In addition to the touch-sensitive surface 531, the input unit 530 may further include the another input device 532. Specifically, the another input device 532 may include, but is not limited to, one or more of a physical keyboard, a function key (such as a volume control key or a switch key), a track ball, a mouse, and a joystick.

The display unit 540 may display information input by the user or information provided for the user, and various graphical user interfaces of the computer device 500. The graphical user interfaces may be formed by a graph, a text, an icon, a video, and any combination thereof. The display unit 540 may include a display panel 541. Optionally, the display panel 541 may be configured by using a liquid crystal display (LCD), an organic light-emitting diode (OLED), or the like. Further, the touch-sensitive surface 531 may cover the display panel 541. After detecting a touch operation on or near the touch-sensitive surface 531, the touch-sensitive surface 531 transfers the touch operation to the processor 580, so as to determine a type of a touch event. Then, the processor 580 provides corresponding visual output on the display panel 541 according to the type of the touch event. Although, in FIG. 5, the touch-sensitive surface 531 and the display panel 541 are used as two separate parts to implement input and output functions, in some embodiments, the touch-sensitive surface 531 and the display panel 541 may be integrated to implement the input and output functions.

The computer device 500 may further include at least one sensor 550, such as an optical sensor, a motion sensor, and other sensors. Specifically, the light sensor may include an ambient light sensor and a proximity sensor. The ambient light sensor may adjust luminance of the display panel 541 according to brightness of ambient light. The proximity sensor may switch off the display panel 541 and/or backlight when the computer device 500 is moved to the ear. As one type of motion sensor, a gravity acceleration sensor may detect magnitude of accelerations in various directions (which are generally triaxial), may detect magnitude and a direction of the gravity when static, and may identify an application of a computer device posture (such as switchover between horizontal and vertical screens, a related game, and gesture calibration of a magnetometer), a related function of vibration identification (such as a pedometer and a knock). Other sensors, such as a gyroscope, a barometer, a hygrometer, a thermometer, and an infrared sensor, which may be further configured in the computer device 500, are not further described herein.

The audio circuit 560, a loudspeaker 561, and a microphone 562 may provide audio interfaces between the user and the computer device 500. The audio circuit 560 may transmit, to the loudspeaker 561, a received electrical signal converted from audio data. The loudspeaker 561 converts the electrical signal into a voice signal for output. On the other hand, the microphone 562 converts a collected sound signal into an electrical signal. The audio circuit 560 receives the electrical signal and converts the electrical signal into audio data, and outputs the audio data to the processor 580 for processing. Then, the processor 580 sends the audio data to, for example, another terminal by using the RF circuit 510, or outputs the audio data to the memory 520 for further processing. The audio circuit 560 may further include an earplug jack, so as to provide communication between a peripheral earphone and the computer device 500.

WiFi belongs to a short distance wireless transmission technology. The computer device 500 may help, by using the WiFi module 570, a user receive and send an email, browse a Web page, and access stream media, and the like, which provides wireless broadband Internet access for the user. Although FIG. 5 shows the WiFi module 570, it may be understood that, the WiFi module 570 does not belong to a necessary constitution of the computer device 500, and can be ignored completely according to demands without changing the scope of the essence of the present disclosure.

The processor 580 is a control center of the computer device 500, and connects various parts of the computer device by using various interfaces and lines. By running or executing the software program and/or module stored in the memory 520, and invoking the data stored in the memory 520, the processor 580 performs various functions and data processing of the computer device 500, thereby performing overall monitoring on the computer device. Optionally, the processor 580 may include one or more processing cores. Preferably, the processor 580 may integrate an application processor and a modem. The application processor mainly processes an operating system, a user interface, an application program, and the like. The modem mainly processes wireless communication. It may be understood that, the foregoing modem may be not integrated into the processor 580.

The computer device 500 further includes the power supply 590 (such as a battery) for supplying power to the components. Preferably, the power supply may be logically connected to the processor 580 by using a power supply management system, thereby implementing functions, such as charging, discharging, and power consumption management, by using the power supply management system. The power supply 590 may further include any component, such as one or more direct current or alternating current power supplies, a recharging system, a power supply fault detection circuit, a power supply converter or an inverter, and a power supply state indicator.

Although not shown in the figure, the computer device 500 may further include a camera, a Bluetooth module, and the like, which are not further described herein.

Specifically, in some embodiments of the present invention, the processor 580 includes a CPU 581 and a GPU 582, and the computer device further includes a memory and one or more programs. The one or more programs are stored in the memory, and are configured to be executed by the CPU 581. The one or more programs include instructions for performing the following operations: determining ray points that use a to-be-rendered target object as a center and are distributed in a spherical shape or a semispherical shape; and establishing, at a position of each ray point, a ray light source that radiates light towards the to-be-rendered target object.

In addition, the one or more programs that are configured to be executed by the GPU 582 include instructions for performing the following operations: receiving information, which is sent by the CPU 581, about a scene within a preset range around a to-be-rendered target object; rendering the received scene to obtain scene depth parameters, where the scene is obtained through shooting by a camera located at a ray light source; rendering the to-be-rendered target object to obtain rendering depth parameters, where the to-be-rendered target object is obtained through shooting by a camera not located at a ray light source; calculating AO maps of the to-be-rendered target object in directions of ray light sources according to the scene depth parameters and the rendering depth parameters; and overlaying the AO maps in the directions of the ray light sources, to obtain an output image.

It is assumed that, the foregoing is a first possible implementation manner, and then in a second possible implementation manner provided based on the first possible implementation manner, the one or more programs executed by the GPU 582 further include instructions for performing the following operations: for each ray light source, calculating an AO value of each pixel point in a direction of the ray light source according to a scene depth parameter and a rendering depth parameter of each pixel point of the to-be-rendered target object; and overlaying the AO values to obtain an AO map of the to-be-rendered target object in the direction of the ray light source.

In a third possible implementation manner provided based on the second possible implementation manner, the one or more programs executed by the GPU 582 further include instructions for performing the following operations: calculating, according to the scene depth parameter and the rendering depth parameter of each pixel point, a shadow value of the pixel point; and multiplying the shadow value of the pixel point by a weight coefficient, to obtain the AO value of the pixel point in the direction of the ray light source, where the weight coefficient includes a dot product of an illumination direction of the ray light source and a normal direction of the pixel point, and a reciprocal of a total number of the ray light sources.

In a fourth possible implementation manner provided based on the third possible implementation manner, the one or more programs executed by the GPU 582 further include instructions for performing the following operations: determining, when the rendering depth parameter of the pixel point is greater than the scene depth parameter, that the shadow value of the pixel point is 1; and determining, when the rendering depth parameter of the pixel point is less than or equal to the scene depth parameter, that the shadow value of the pixel point is 0.

In a fifth possible implementation manner provided based on the first, or second, or third, or fourth possible implementation manner, the one or more programs executed by the GPU 582 further include instructions for performing the following operations: rendering the to-be-rendered target object to obtain a vertex coordinate of the to-be-rendered target object; and multiplying the vertex coordinate by a world coordinate matrix, and then by vision matrixes and projection matrixes of cameras located at the ray light sources, to obtain the rendering depth parameters.

In a sixth possible implementation manner provided based on the first, or second, or third, or fourth possible implementation manner, the one or more programs executed by the GPU 582 further include an instruction for performing the following operation: performing a Gamma correction on the output image and outputting the output image.

In this embodiment, a GPU can calculate AO maps of a to-be-rendered target object in directions of ray light sources only according to scene depth parameters and rendering depth parameters, and can obtain an output image by simply overlaying the AO maps in the directions of the ray light sources, which avoids a complex calculation process in the prior art; and these image calculation and processing processes are completed by the GPU, and a powerful capability of the GPU for processing image data is utilized, which therefore saves an image processing time, and improves image processing efficiency.

It should be additionally noted that, the apparatus embodiments described above are only schematic. Units described as separate components may be or may not be physically separate, and parts displayed as units may be or may not be physical units, may be located in one position, or may be distributed to multiple network units. Some or all of the units may be selected according to actual needs to achieve the objectives of the solutions of the embodiments. In addition, in the accompanying drawings of the apparatus embodiments provided by the present disclosure, a connection relationship between the units indicates that there is a communication connection between them, and may be specifically implemented as one or more communications buses or signal lines. A person of ordinary skill in the art can understand and carry out the solution without creative efforts.

Through the descriptions of the foregoing embodiments, a person skilled in the art may clearly understand that the present disclosure may be implemented by software plus necessary universal hardware, and certainly may also be implemented by specific hardware including a specific integrated circuit, a specific CPU, a specific memory, and a specific component. In a normal case, all functions completed by a computer program can be easily implemented by using corresponding hardware, and specific hardware structures for implementing a same function may also be varied, for example, an analog circuit, a digital circuit, or a specific circuit. However, for the present disclosure, in more cases, an implementation by using a software program is a better implementation manner. Based on such an understanding, the technical solutions of the present disclosure essentially or the part contributing to the prior art may be implemented in a form of a software product. The computer software product is stored in a readable storage medium, such as a floppy disk, a USB disk, a removable hard disk, a read-only memory (ROM), a RAM, a magnetic disk, an optical disc, or the like in a computer, and includes several instructions for instructing a computer device (which may be a personal computer, a server, or a network device) to perform the methods described in the embodiments of the present invention.

The image processing method and apparatus, and the computer device that are provided by the embodiments of the present invention are described in detail above. For a person of ordinary skill in the art, modifications may be made to specific implementation manners and the application scope according to the idea of the embodiments of the present invention. Therefore, the content of the specification shall not be construed as a limit to the present disclosure.

What is claimed is:

1. An image processing method, comprising:
receiving, by a graphic processing unit (GPU), information, which is sent by a central processing unit (CPU), about a scene within a preset range around a to-be-rendered target object;
rendering, by the GPU, the scene to obtain scene depth parameters, wherein the scene is obtained through shooting by a camera located at a ray light source;
rendering, by the GPU, the to-be-rendered target object to obtain rendering depth parameters, wherein the to-be-rendered target object is obtained through shooting by a camera not located at a ray light source;
calculating, by the GPU, ambient occlusion (AO) maps of the to-be-rendered target object in directions of ray light sources according to the scene depth parameters and the rendering depth parameters; and
overlaying, by the GPU, the AO maps in the directions of the ray light sources, to obtain an output image.

2. The image processing method according to claim 1, wherein the calculating, by the GPU, AO maps of the to-be-rendered target object in directions of ray light sources according to the scene depth parameters and the rendering depth parameters comprises:
for each ray light source, calculating, by the GPU, an AO value of each pixel point in a direction of the ray light source according to a scene depth parameter and a rendering depth parameter of each pixel point of the to-be-rendered target object; and
overlaying, by the GPU, the AO values to obtain an AO map of the to-be-rendered target object in the direction of the ray light source.

3. The image processing method according to claim 2, wherein the calculating, by the GPU, an AO value of each pixel point in a direction of the ray light source according to a scene depth parameter and a rendering depth parameter of each pixel point of the to-be-rendered target object comprises:
calculating, by the GPU according to the scene depth parameter and the rendering depth parameter of each pixel point, a shadow value of the pixel point; and
multiplying, by the GPU, the shadow value of the pixel point by a weight coefficient, to obtain the AO value of the pixel point in the direction of the ray light source, wherein the weight coefficient comprises a dot product of an illumination direction of the ray light source and a normal direction of the pixel point, and a reciprocal of a total number of the ray light sources.

4. The image processing method according to claim 3, wherein the calculating, by the GPU according to the scene depth parameter and the rendering depth parameter of each pixel point, a shadow value of the pixel point comprises:
determining, when the rendering depth parameter of the pixel point is greater than the scene depth parameter, that the shadow value of the pixel point is 1; and
determining, when the rendering depth parameter of the pixel point is less than or equal to the scene depth parameter, that the shadow value of the pixel point is 0.

5. The image processing method according to claim 1, before the receiving, by a GPU, information, which is sent by a CPU, about a scene within a preset range around a to-be-rendered target object, further comprising:
determining, by the CPU, ray points that use the to-be-rendered target object as a center and are distributed in a spherical shape or a semispherical shape; and
establishing, by the CPU, at a position of each ray point, a ray light source that radiates light towards the to-be-rendered target object.

6. The image processing method according to claim 1, wherein the rendering, by the GPU, the to-be-rendered target object to obtain rendering depth parameters comprises:
rendering, by the GPU, the to-be-rendered target object to obtain a vertex coordinate of the to-be-rendered target object; and
multiplying, by the GPU, the vertex coordinate by a world coordinate matrix, and then by vision matrixes and projection matrixes of cameras located at the ray light sources, to obtain the rendering depth parameters.

7. The image processing method according to claim 1, after the overlaying, by the GPU, the AO maps in the directions of the ray light sources, to obtain an output image, further comprising:
performing a Gamma correction on the output image and outputting the output image.

8. The image processing method according to claim 1, wherein the number of the ray light sources is 900.

9. An image processing apparatus, comprising:
a receiving unit, that receives information, which is sent by a central processing unit (CPU), about a scene within a preset range around a to-be-rendered target object;
a rendering processing unit, that renders the scene to obtain scene depth parameters, wherein the scene is obtained through shooting by a camera located at a ray light source, and renders the to-be-rendered target object to obtain rendering depth parameters, wherein the to-be-rendered target object is obtained through shooting by a camera not located at a ray light source;
a map generating unit, that calculates ambient occlusion (AO) maps of the to-be-rendered target object in directions of ray light sources according to the scene depth parameters and the rendering depth parameters; and
an output processing unit, that overlays the AO maps in the directions of the ray light sources, to obtain an output image.

10. The image processing apparatus according to claim 9, wherein the map generating unit comprises:
a calculation unit, for each ray light source, that calculate an AO value of each pixel point in a direction of the ray light source according to a scene depth parameter and a rendering depth parameter of each pixel point of the to-be-rendered target object; and
a map generating subunit, that overlays the AO values to obtain an AO map of the to-be-rendered target object in the direction of the ray light source.

11. The image processing apparatus according to claim 10, wherein the calculation unit specifically:
calculates, according to the scene depth parameter and the rendering depth parameter of each pixel point, a shadow value of the pixel point; and
multiplies the shadow value of the pixel point by a weight coefficient, to obtain the AO value of the pixel point in the direction of the ray light source, wherein the weight coefficient comprises a dot product of an illumination direction of the ray light source and a normal direction of the pixel point, and a reciprocal of a total number of the ray light sources.

12. The image processing apparatus according to claim 11, wherein the calculating, by the calculation unit according to the scene depth parameter and the rendering depth parameter of each pixel point, a shadow value of the pixel point comprises:
determining, by the calculation unit when the rendering depth parameter of the pixel point is greater than the scene depth parameter, that the shadow value of the pixel point is 1; and
determining, by the calculation unit when the rendering depth parameter of the pixel point is less than or equal to the scene depth parameter, that the shadow value of the pixel point is 0.

13. The image processing apparatus according to claim 9, wherein the rendering, by the rendering processing unit, the to-be-rendered target object to obtain rendering depth parameters comprises:
rendering, by the rendering processing unit, the to-be-rendered target object to obtain a vertex coordinate of the to-be-rendered target object; and multiplying the vertex coordinate by a world coordinate matrix, and then by vision matrixes and projection matrixes of cameras located at the ray light sources, to obtain the rendering depth parameters.

14. The image processing apparatus according to claim 9, further comprising:
a correction unit, that performs a Gamma correction on the output image and output the output image.

15. The image processing apparatus according to claim 9, wherein the number of the ray light sources is 900.

16. A computer device, wherein the computer device comprises a central processing unit (CPU) and a graphic processing unit (GPU), wherein
the CPU determines ray points that use a to-be-rendered target object as a center and are distributed in a spherical shape or a semispherical shape, and establishes, at a position of each ray point, a ray light source that radiates light towards the to-be-rendered target object; and
the GPU receives information, which is sent by the CPU, about a scene within a preset range around a to-be-rendered target object; renders the scene to obtain scene depth parameters, wherein the scene is obtained through shooting by a camera located at a ray light source; renders the to-be-rendered target object to obtain rendering depth parameters, wherein the to-be-rendered target object is obtained through shooting by a camera not located at a ray light source; calculates ambient occlusion (AO) maps of the to-be-rendered target object in directions of ray light sources according to the scene depth parameters and the rendering depth parameters; and overlays the AO maps in the directions of the ray light sources, to obtain an output image.

17. The computer device according to claim 16, wherein the calculating, by the GPU, AO maps of the to-be-rendered target object in directions of ray light sources according to the scene depth parameters and the rendering depth parameters comprises:
for each ray light source, calculating, by the GPU, an AO value of each pixel point in a direction of the ray light source according to a scene depth parameter and a rendering depth parameter of each pixel point of the to-be-rendered target object; and
overlaying, by the GPU, the AO values to obtain an AO map of the to-be-rendered target object in the direction of the ray light source.

18. The computer device according to claim 17, wherein the calculating, by the GPU, an AO value of each pixel point in a direction of the ray light source according to a scene depth parameter and a rendering depth parameter of each pixel point of the to-be-rendered target object comprises:
calculating, by the GPU according to the scene depth parameter and the rendering depth parameter of each pixel point, a shadow value of the pixel point; and
multiplying, by the GPU, the shadow value of the pixel point by a weight coefficient, to obtain the AO value of the pixel point in the direction of the ray light source, wherein the weight coefficient comprises a dot product of an illumination direction of the ray light source and a normal direction of the pixel point, and a reciprocal of a total number of the ray light sources.

19. The computer device according to claim 18, wherein the calculating, by the GPU according to the scene depth parameter and the rendering depth parameter of each pixel point, a shadow value of the pixel point comprises:
determining, by the GPU when the rendering depth parameter of the pixel point is greater than the scene depth parameter, that the shadow value of the pixel point is 1; and
determining, by the GPU when the rendering depth parameter of the pixel point is less than or equal to the scene depth parameter, that the shadow value of the pixel point is 0.

20. The computer device according to claim 16, wherein the rendering, by the GPU, the to-be-rendered target object to obtain rendering depth parameters comprises:
rendering, by the GPU, the to-be-rendered target object to obtain a vertex coordinate of the to-be-rendered target object; and
multiplying, by the GPU, the vertex coordinate by a world coordinate matrix, and then by vision matrixes and projection matrixes of cameras located at the ray light sources, to obtain the rendering depth parameters.
